(19) United States
(12) Patent Application Publication
(10) Pub. No.: US 2002/0114021 A1
(43) Pub. Date: Aug. 22, 2002

(54) Document scanning system

(76) Inventors: Scott D. Lavender, Rochester, NY (US); Michael Beyerlein, Rochester, NY (US); Leonard R. Christopher, Fairport, NY (US)

Correspondence Address: Stephen B. Salai, Esq., Harter, Secrest & Emery LLP, 1600 Bausch & Lomb Place, Rochester, NY, 14604-2711, US

(21) Appl. No.: 09/783,691

(22) Filed: Feb. 14, 2001

(51) Int. Cl. B41F 1/00; B41B 1/00

(52) U.S. Cl. 358/474; 358/505

(57) ABSTRACT

A document scanning system is configured to submit user selected scanning parameters to a scanner from any one of a plurality of locations. The system includes a lockout to preclude execution of subsequently submitted scanning parameters prior to completion of a previously submitted scan job. The system further provides for delayed execution of a submitted scan job until the user has provided a confirmation signal.

### FIELD OF THE INVENTION

The present invention relates to a document scanning system, and more particularly to the management of a scanner and a printer through an independent scanner computer and printer computer, wherein user selected scanning parameters can be submitted through the printer computer and the scanner computer.

### BACKGROUND OF THE INVENTION

Electrophotographic copying has long been known, and is currently applied in machines ranging from small office copiers to a large-scale production of documents. The large scale in this context might embrace inhouse publishing by a business, where the number of copies would be large enough to satisfy internal needs, while falling far short of the numbers and printing speeds required for example in newspaper or book publishing for public consumption.

The current generation of electrophotographic copiers and printers are digitally based. Producing a copy of an image involves scanning an image, digitally recording the scanned image, storing the recorded image, transmitting the stored image to a printing device, and printing the image. The scanned image may be magnified, reduced or otherwise manipulated prior to being printed.

In order to take full advantage of large scan-print systems, there is a need to provide means for controlling such systems from multiple locations.

### SUMMARY OF THE INVENTION

The present invention provides a document scanning system having a scanner connected to a separate and independent first computer, the first computer having a scanner interface, and a printer connected to a second separate and independent computer, the second computer having a printer interface, wherein the first computer and the second computer are operably interconnected. The scanner is selectively controlled by scanning parameters, which are input and submitted to the scanner by a user through the printer interface or the scanner interface. Thus, the system allows a user to select and input scanning parameters from the scanner interface or the printer interface to define a scan job to be executed by the scanner.

In a further configuration of the system, the invention precludes scanning parameters for subsequently submitted scan jobs from being executed until scanning parameters for current or previously submitted scan jobs have been completed. The system also permits the scanning parameters for subsequently submitted scanning jobs to be identified and placed in a queue.

An additional configuration of the invention provides for the delayed execution of submitted scanning parameters until a confirmation or secondary input has been provided by the user.

The present invention further provides a printer that can be operably connected to a plurality of computers, wherein each computer is operably connected to a corresponding scanner, thereby allowing the printer to receive information scanned from any of the plurality of scanners.

The present invention further provides for the disposition of resulting files from execution of the scanning parameters. The files can be stored, printed, or stored and printed. Further, stored files can be selectively retrieved, sorted, reordered, modified and combined in conjunction with the execution of a scan job.

### BRIEF DESCRIPTION OF THE DRAWINGS

FIG. 1 is a schematic drawing of the document scanning system.

FIG. 2 is a flow chart representing submission of a scan job in the document scanning system.

FIG. 3 is a flow chart representing additional functions of the document scanning system.

### DETAILED DESCRIPTION OF THE PREFERRED EMBODIMENTS

Referring to the drawings, the present invention includes a document scanning system 10 for selectively scanning a document to form a corresponding electronic file, referred to herein as a scan job.

The term “scan job” includes the scanning, creation of a corresponding file and storing of the file. However, it is understood the scan job can also include the scanning and printing of the document without any permanent storage of the scanned image file. The scan job is at least partially defined by user selected, and input, scanning parameters. The scanning parameters include, but are not strictly limited to, an automatic or manual initiation of the scan job, the type of document to be scanned such as photograph, text, drawing color, or black and white, picture controls such as contrast, brightness, the storage location of the file, the printing of the file, the parameters for controlling the printing of the file, including paper size, image reduction or enlargement and orientation as well as the process applied to the file, such as storing, storing and printing or printing. Therefore, the term scan job, includes and encompasses a corresponding set of scanning parameters. The submission of a scan job thus includes the submission of scanning parameters for the given scan job.

For purposes of description, the term “document” encompasses the item to be scanned, wherein the document can be a single page or sheet, or a plurality of pages or sheets, such that the pages are of similar size or varying size. The document can include text, images, charts, graphs or any other visual indicia. The document can be paper, plastic of any other substrate upon which visual indicia can be retained. The document can be bound or loose leaf. When the original document is scanned, the scanned image is stored electronically in a corresponding file. While various storage paradigms are possible, the present system is configured to create a separate file for each page or sheet of the document.

The document scanning system 10 includes a scanner 20, a scanner computer 22, a printer 30 and a printer computer 32.

The scanner 20 is any commercially available scanner selected to scan a document and produce a corresponding electronic representation in the form of a file. To enhance efficiency, the scanner 20 can include a sheet feeder, which can be an automatic sheet feeder 26. The scanner 20 includes a number of control inputs for operating the scanner as a stand-alone device. One of the control inputs is a start or scan button, which causes the scanner to scan. It is understood the scanner 20 can also include a display to indicate status of the scanner.

The scanner computer 22 is connected to the scanner 20 and a switching unit or hub 12. The scanner computer 22 can be any of a variety of configurations or workstations, such as by IBM or Sun. In a preferred configuration, the scanner computer 22 includes, or is connected to, a storage device for electronic data. The storage device can be any of a variety of configurations including tape drives, hard drives and optical storage. The scanner computer 22 includes a corresponding display 40 and an input. The display can be any of a variety of devices such as CRT, LED, LCD or flat panel. The input can be any of variety of devices including keyboards, keypads or control sticks. A preferred input includes software that cooperates with the display to form a touch sensitive screen according to the software. The software is preferably selected to prompt and receive the variety of scanning parameters. The scanner computer 22 thus provides a scanner user interface 24 by which scanning parameters can be sent to the scanner 20.

The printer computer 32 is connected to the printer 30 and the hub 12. The printer computer 32 can be any of a variety of configurations or workstations, with a preferred computer by Sun. In a preferred configuration, the printer computer 32 includes, or is connected to, a storage device 36 for electronic data. The storage device 36 can be any of a variety of configurations including tape drives, hard drives and optical storage. The printer computer 32 includes a corresponding display 40 and an input. The display can be any of a variety of devices such as CRT, LED, LCD or flat panel. The input can be any of variety of devices including keyboards, keypads or control sticks. A preferred input cooperates with the display to form a touch sensitive screen. The printer computer 32 thus provides a printer user interface 34 by which scanning parameters can be sent to the scanner 20.

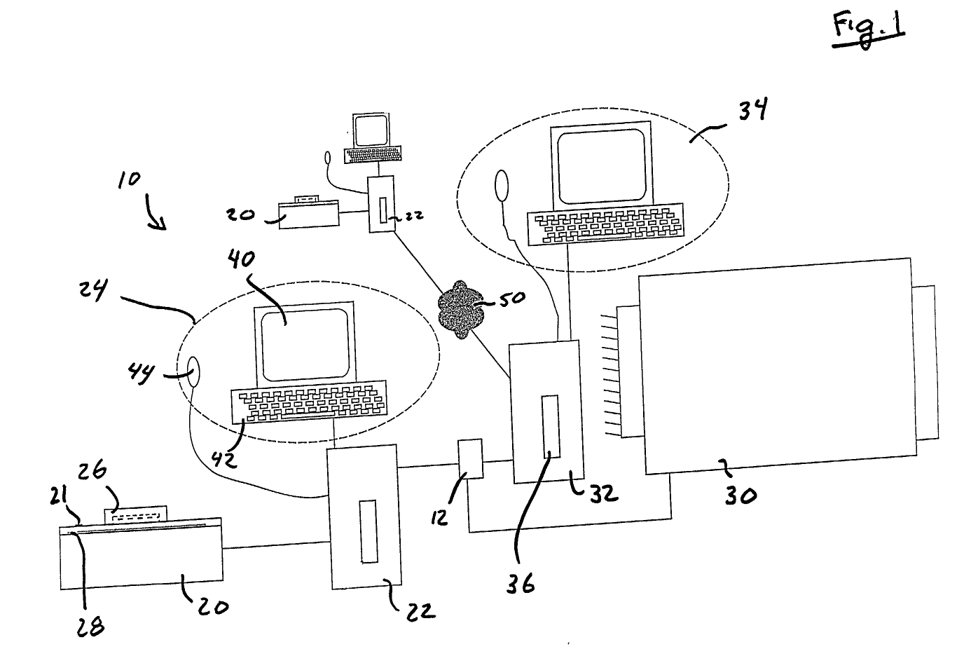

In FIG. 1, each of the scanner computer 22 and the printer computer 32 include the display, a keyboard and a mouse with associated software (not shown), although it is understood that other devices may be present.

The printer 30 can be any of a variety of commercially available configurations such as the DigiMaster 9110 by Heidelberg Digital. The printer 30 is selected to produce a printed image in response to an electronic input. The printer 30 can include a plurality of paper feed trays for selectively employing different paper sizes or paper types. In a preferred configuration, the printer 30 can print both sides of a given sheet.

The switching unit or hub 12 is any of a variety of commercially available devices, such as a 3Comm 10/100 Base-TX switching unit running at 100 MB throughput. The hub 12 is connected to the scanner computer 22 and the printer computer 32. The printer computer 32 is connected to the printer 30 and the hub 12. In a typical configuration, the scanner 20, the scanner computer 22, the printer computer 32 and the printer 30 are in proximity with each other. However, it is understood scanners and their associated computers can be remotely located in another room or building. The hub 12 can also be connected to a network 50, such as the Internet or an intranet, to one or more remote scanners, each scanner having an associated computer. The scanner 20, the scanner computer 22, the printer 30 and the printer computer 32 are selected to provide communication among the components. That is, the scanner computer 22 can send and receive control signals as well as data signals from the scanner 20, and the printer computer 32 can communicate with the scanner computer 22 to provide corresponding signals to the printer 30, in a language compatible to the printer. Thus, each component can employ a common computer language. Alternatively, the scanner 20 and the printer 30 can employ separate computer languages, wherein the scanner computer 22 and the printer computer 32 provide a common language connection. The term associated computer is intended to encompass computers having software and associated hardware for forming a user interface, through which scanning parameters can be input and subsequently communicated to the scanner, in a language that can be implemented, or understood, by the corresponding scanner.

The document scanning system 10 is configured so that the scanner 20 can be controlled through the user submitted scanning parameters of a scan job submitted from the user interface 24, 34 at either the scanner computer 22 or at the printer computer 32 to producing the resulting corresponding file of the scanned image. That is, the scanning parameters can be input through the scanner user interface or the printer user interface.

A set of the input scanning parameters for a given scan job can contain scanning parameter subsets. Each scanning parameter subset can control the scanning of a corresponding portion or page of the document. For example, a portion of the document can include a photographic image which requires a better imaging quality than a portion containing only text, and a different scanning parameter subset will be inputted to control the scanning of such a portion. A straightforward scan job may require no variation in scanning parameters, in which case it may considered that that scanning is controlled by a single scanning parameter subset which is identical to the overall scanning parameter set.

The document scanning system 10 has a lockout feature which ensures the scan jobs are performed on a “first come first served” basis. Lockout software typically resides at the printer computer 32 with corresponding cooperating software at the scanner computer 22. The lockout feature allows or denies execution of a scan job by the scanner 20 in response to a request which is routed through the printer computer 32, regardless of which user interface originated the scan job. Once the current scan job has been submitted, a subsequently submitted scan job cannot be scanned until the first scan job is complete. Depending on the nature of the scan job, the scanning parameters entered by the user provide that the document scanning system 10 recognizes its completion either automatically or manually. In an automatic feed mode, the scanning job is recognized as complete when all sheets have been delivered by the feeder 26 for scanning, as is known for example in the art of paper feeding devices for copying machines. Typically, after the last sheet of a document has been delivered, a mechanical device is enabled to provide a corresponding signal. It is understood that an automatic scan job can include a single sheet and be scanned from the platen or glass of the scanner 20. That is, the automatic mode is not limited to using the feeder. In a manual feed mode, the scanning job is recognized as complete when the user has provided a manual signal to that effect, such as through the scan job done button on the user interface which submitted the scanning parameters. Thus, upon actuation of the lock out feature, software at the printer computer 32 queries the scanner computer 22 to determine whether the scanner 20 is available.

The lockout operates regardless of whether the subsequent scan job is submitted from the same interface or a different interface from the prior scan job. Thus, a successful submission of scanning parameters causes the user to effectively “own” the scanner 20 and the scan job done button appears at the user interface through which the scan job was submitted. If a newly submitted scan job cannot be executed because of an existing scan job, this information appears in a dialog box in the user interface. In one embodiment, the dialog box informs the user that the new scan job needs to be resubmitted after completion of the prior scan job. Thus, the status of the scanner 20 can be monitored at the user interface and the user can resubmit the scan job upon the scanner 20 becoming available. In an alternative embodiment, the dialog box informs the user that the new scan job has entered a queue, and will be executed when the prior scan job(s) in the queue ahead of the new scan job have been performed. In other words, scan jobs in the queue are processed in a FIFO (first in, first out) sequence. Optionally, the dialog box can inform the user how many scan jobs are in the queue at the time the new job is submitted and may allow a reordering of the scan jobs in the queue. It is understood that the status of the scanner 20 can be viewed from any user interface that is part of the document scanning system 10. In practice, it has been found successful to locate the lockout software on the printer computer 32, such that a scan job request is directed to the scanner computer 22, which determines the availability of the scanner 20. The availability of the scanner 20 is directed from the scanner computer 22 to the printer computer 32. The lockout program then displays to the user the successful submission of the scan job or the scanner status dialog box.

Regardless of where the scanning parameters are input, the document is physically and manually presented into the scanner 20. The presentation to the scanner 20 can be on a sheet by sheet basis or a batch basis. Typically, the document is in the form of a succession of identically sized sheets. In this case, the original document is placed in the feeder 26, and once the scan job has commenced, the sheets are automatically fed and scanned successively. However, there are occasions when the original document does not lend itself to automatic feeding, as for example the pages of a book. In such a case, each page must be positioned manually between the scanning of successive images.

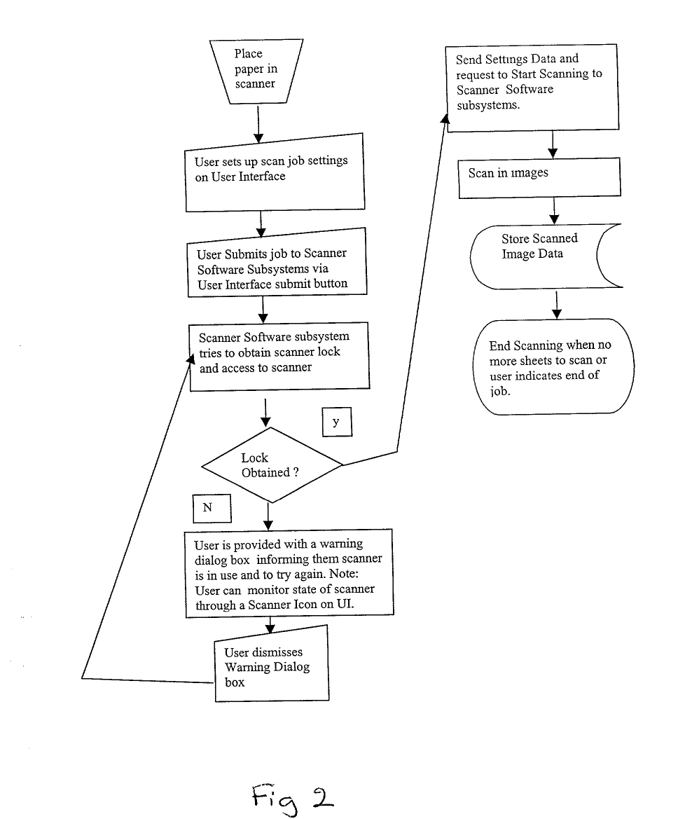

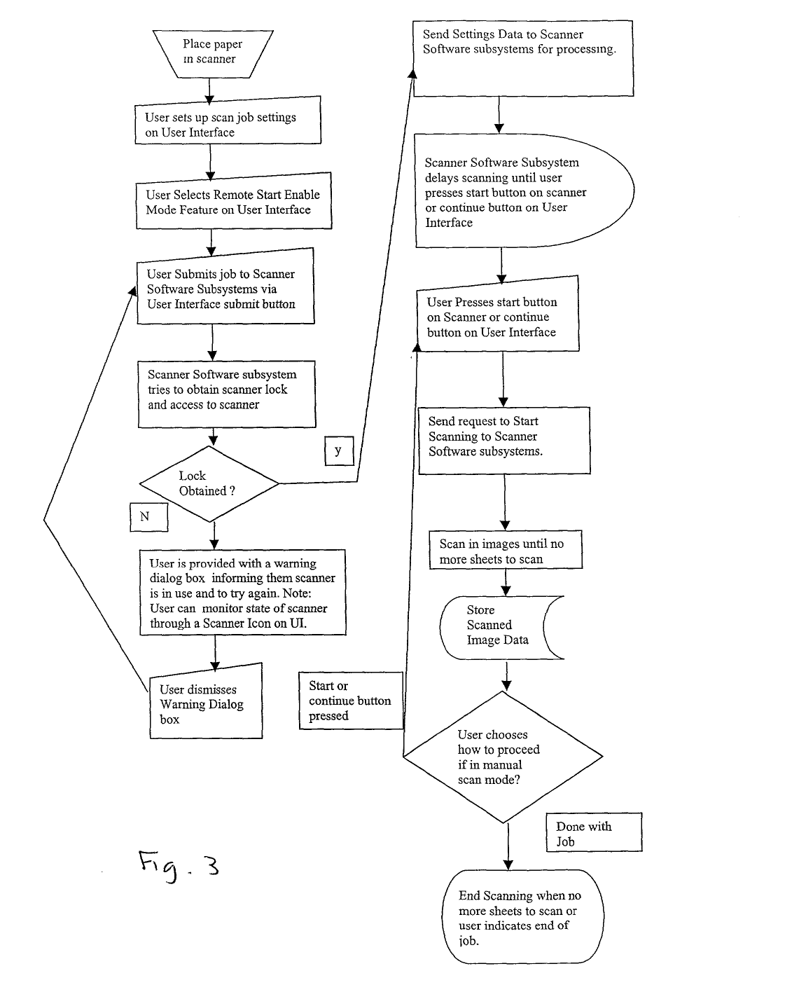

Examples of executing scan jobs follow. FIGS. 2 and 3 are typical flow charts provided for more general reference rather than to indicate all the particulars of a specific job. FIG. 2 demonstrates the use of the lockout, and FIG. 3 applies to a manual scan job in which submitted scanning parameters are delayed until confirmation by the user, such as the remote start enabled feature.

In one example of a scan job, the entire document includes a single stack of individual sheets which can placed in the feeder 26 and processed in an uninterrupted fashion. As is known in the art of copying machines, the scanner 20 is equipped to sense the presence of the original document in the feeder 26, and to recognize when all the sheets have been scanned.

The user can select to control the scan job from the scanner user interface 24 or the printer user interface 34. The user first activates a “Scan” button from a selection of tools at the user interface. This instructs the document scanning system 10 that a scan job is to be performed. Activating a “jobs destination” tab then provides a choice of options including “Print”, “Store” and “Print and Store”. An “Auto” and a “Manual” choice is provided through a pull down menu or pop up window to instruct the running of the job in the corresponding automatic feed mode or manual feed mode.

The user then has the opportunity to enter further desired scanning parameters at the user interface. If no variation of scanning parameters will be needed through the entire job, the user can select “Auto” . Once the scanning parameter set has been entered, the user activates a “Submit Job” button in the user interface, which appears on the corresponding display. If all previously submitted scan jobs have been completed, activation of the “Submit Job” button at the user interface will cause the scan job to commence. As is known in the art, each successive sheet of the document is transported from the feeder 26, scanned and placed in a scanned stack. Thus, a sheet can be scanned from platen, and if in the auto mode, the scan job is deemed complete. In the “Auto” mode, the scan job is considered complete when the entire original document has been scanned, and the document scanning system 10 is then free to accept a subsequently submitted scan job.

In the “Manual” mode, the document scanning system 10 provides that the scan job will not be considered complete until the user enters a signal to that effect. Thus, the user may employ the feeder or the platen of the scanner 20 for scanning selected portions of the document. Specifically, the “Scan Job Done” button appears at the user interface where the job was submitted. The “Scan Job Done” button allows the user to signal the completion of the given scan job, thereby releasing the scanner from control. The “Manual” mode is used when it is desired to specify different scanning parameters for different portions of the original document, or when the original document cannot be fed automatically. For example, an original document may have some pages of text only and other pages, which include photographs requiring a better image quality. The user activates and enters a scanning parameter subset for a first page or block of pages, places the page(s) in the feeder and activates the “Submit Job” button. If all previously submitted scan jobs have been completed, scanning commences and proceeds until all pages in the feeder have been scanned. After replacing the contents of the feeder with another page or pages, the user enters another scanning parameter subset and activates a “Continue” button at the user respective interface. When the entire original document has been scanned in the “Manual Mode”, the user actuates the “Scan Job Done” button at the user interface, which indicates to the document scanning system 10 that the scan job is complete and that another scan job (which may already have been set up) can be successfully submitted.

In another example, the document includes multiple stacks, which in their totality cannot be accepted by the feeder 26. The user may elect to scan each stack separately in “Auto” mode, but completion of each stack automatically signals that the document scanning system 10 may accept another submitted job, and the user may then lose precedence for the following stack. It is therefore preferred to run such a document in “Manual” mode, even when there is no variation in scanning parameters. The user then proceeds in the same manner as was described for the previous example.

In yet another example, the document is a book, which cannot be handled by the feeder 26. Such a document is scanned in “Manual” mode, wherein the book being placed so that the required image is positioned on a platen 28. The user inputs the desired scanning parameter set for the first image, and actuates the “Submit Job” button, causing the image to be scanned. To scan a further image, the user manually places the image in position and actuates the “Continue” button at the scanner interface 24, or a dedicated “Start” button 21 at the scanner. The “Continue” button becomes selectable after each image is scanned. Alternatively, the dedicated start button can be controlled such that it is actuatable in the Enable Remote Scan mode as set forth herein. The procedure is repeated until all required images have been scanned. After the final image has been scanned, the user actuates the “Scan Job Done” button which appears at the user interface through which the scan job was submitted. Again, in a preferred configuration, the scan job can be entered through either user interface and the “Scan Job Done” button can be activated at the respective user interface.

In an embodiment, which lends itself particularly to scanning from a book, an “Enable Remote Scan” button is provided at the user interface. This button can be enabled or disabled. When Enable Remote Scan is enabled, actuation of the “Submit Job” button submits the scan job to the scanner 20, but scanning is delayed until the user provides a further signal. The further signal is provided by user activation of a start or scan button 21 on the scanner 20, or a “Continue” button in the user interface through which the scan job was submitted. Specifically, the user places the first sheet on the platen 28, then provides an input confirmation signal at the scanner 20 by actuating the “Start” button 21 on the scanner 20. After the first image is scanned, the user continues by alternately positioning successive images and reacuating the “Start” button 21. When all required images have been scanned, the user actuates the “Scan Job Done” button at the user interface through which the scan job was submitted. Thus, the Enable Remote Scan feature requires a second or confirmation input, through the scanner or a user interface, subsequent to successful submission of the scan job and prior to initiation of the scanning by the scanner 20. In the Manual mode of operation, it is contemplated the user can toggle in and out of the Enable Remote Scan feature.

In “Manual” mode, a succession of images from a stack and an image from a book can both be regarded as image subsets. In either case, the “Start” button 21 or “Continue” button must be actuated between the scanning of successive subsets, and the job is completed by actuating the “Scan Job Done” button after the final subset has been scanned. Of course, it may not be necessary to change the scanning parameters of a manually scanned original document. In such a case, it may be considered that all the subsets of scanning parameters are identical to each other and to the overall parameter set.

It is emphasized that the “Submit Job” button is only activated once for a given manual scan job, even though the original document is scanned as discrete image subsets.

Further, the user may select any of the instructions “Print”, “Store” and “Print and Store” for processing the scanned document. When “Store” or “Print and Store” are selected, each scanned image is saved individually in a corresponding electronic file, from which it may subsequently be retrieved. Each stored file can be modified if it is desired to alter the stored image compared with the original image. For example, a photographic image may be reduced, enlarged, cropped, made brighter or darker, have its contrast increased or reduced, or have its color balance changed. A copy derived from the document, but not necessarily identical with the document, may be printed from the stored images.

In summary, when a document is scanned from the feeder 26, actuating the “Submit Job” button causes scanning to commence (if the scan job is accepted) pursuant to the user input scanning parameters and continue until the current contents of the feeder are exhausted. In “Auto” mode, this automatically terminates the scan job, while in “Manual” mode, the user has an opportunity to reload and continue scanning by actuating the “Start” button 21 at the scanner 20, or the “Continue” button. The “Continue” button overlays the “Submit Job” button at the respective user interface either as a non-selectable or a selectable button. It becomes selectable each time a stack is exhausted when the system is in “Manual” mode. To signify completion of the scan job, the user actuates the “Scan Job Done” button. The “Enable Remote Scan” button can be activated or deactivated according to user preference at successive stages of a scan job performed in “Manual” mode. When activated, it provides that scanning of a current image subset be delayed until the user actuates the “Start” button 21 at the scanner 20.

Even though the printer interface 34 provides the user with the option of controlling the scanner 20, it is not necessary that a scanned document be printed at the time of scanning, although this will probably be the case. Deployment of the “Store” button allows the user to completely scan the original document and store the scanned images for later printing. The delay in printing has no bearing on the lockout feature; once scanning is complete, the system is free to scan another document, regardless of whether the stored images are printed.

The provision of both the scanner interface 24 and the printer interface 34 is a great advantage in organizing the work of a printing facility. In one scenario, a single user oversees both the scanner 20 and the printer 30, and during the execution of the current print job can be responsible for inputting the scanning parameters for a subsequent scan job. One or other of the user interfaces may be more convenient, depending on the particular jobs being attended to. In another scenario, a first user oversees the scanner 20 and a second user oversees the printer 30, both users having the capability to submit jobs. It is clearly a convenience for the first user to use the scanner user interface 24 and the second user to use the printer user interface 34.

The remote scanner 20 provides a remote user the distinct advantage of being able to submit a distant scan job without having to physically ship the original document to the location of the printer 30. It also allows the remote user to retain control of the scanning parameters, thus avoiding any possible miscommunication.

It is contemplated that a plurality of scanners and associated scanner computers may be operably connected to a given printer and printer computer. For example, a first scanner and first scanner computer, and a second scanner and second scanner computer can be operably connected to a single printer computer (and hence printer) via a network or hub. In such configuration, it is contemplated that the printer computer user interface 34 is selected to allow the input and submission of scanning parameters for either the first scanner or the second scanner, wherein the scanner parameters are passed through the respective scanning computer 22 to the appropriate scanner 20. In a further configuration, the first scanner computer includes a first user interface and the second scanner computer includes a second user interface, wherein the first user interface and the second user interface are selected to receive user selected scanning parameters for either of the first scanner or the second scanner.

The present invention has been described in connection with the foregoing variations and examples, but it is not intended to limit the scope of the invention to the particular form set forth; on the contrary, it is intended to cover such alternatives, modifications, and equivalents as may be included within the spirit and scope of the invention as defined by the appended claims.

We claim:

1. A system for scanning a document pursuant to user selected scanning parameters, the user selected parameters controlling a portion of the scanning of the document, the system comprising:
(a) a scanner selected to scan the document and produce a scanned image file in accordance with the user selected scanning parameters;
(b) a scanner computer connected to the scanner to receive the scanned image file from the scanner, the scanner computer having a scanner user interface for inputting the user selected scanning parameters;
(c) a printer selected to print an image corresponding to the scanned image file; and
(d) a printer computer connected to the printer and the scanner computer, the printer computer having a printer user interface for inputting the user selected scanning parameters.

2. The system of claim 1, wherein the printer computer includes a storage device for storing the scanned image file.

3. The system of claim 1, wherein the printer, the scanner, the scanner computer and the printer computer communicate in a common language.

4. The system of claim 1, wherein the scanner and the scanner computer communicate in a first computer language and the scanner computer and the printer computer communicate in a second different computer language.

5. A document scanning system, comprising:
(a) a scanner having an associated scanner user interface; and
(b) a printer operably connected to the scanner, the printer having an associated printer user interface;
the scanner user interface and the printer user interface selected to receive user selected scanning parameters, and to preclude execution of the scanning parameters prior to execution of previously submitted scanning parameters.

6. The system of claim 5, wherein the scanner user interface and the printer user interface include a lock out indicator.

7. The system of claim 5 further comprising a scanning computer connected to the scanner, wherein the scanner user interface is located on the scanner computer.

8. The system of claim 7, wherein the scanner user interface includes a touch sensitive display screen.

9. The system of claim 5 further comprising a printer computer connected to the printer, wherein the printer user interface is located on the printer computer.

10. The system of claim 9, wherein the printer interface includes a touch sensitive display screen.

11. A document scanning system, comprising:
(a) a scanner for scanning a document in accordance with user selected scanning parameters;
(b) a scanner computer operably connected to the scanner, the scanner computer having a scanner user interface;
(c) a printer; and
(d) a printer computer operably connected to the printer and the scanner, the printer computer having a printer user interface;
the scanner, the scanner computer, the printer and the printer computer selected so that the user selected scanning parameters can be submitted to the scanner through the scanner user interface and the printer user interface.

12. The system of claim 11, further comprising a lockout at one of the scanner user interface and the printer user interface, the lockout selected to preclude the scanner from scanning a document pursuant to and subsequently submitted user selected scanning parameters document prior to completion of a previously submitted user selected scanning parameters.

13. The system of claim 11, further comprising a queue for user selected scanning parameters submitted during execution of previously submitted user selected scanning parameters.

14. The system of claim 13, wherein the queue is a first in-first out sequence.

15. A method of controlling a document scanning system, comprising:
(a) submitting first scanning parameters from one of a scanner user interface and a printer user interface to a scanner for controlling the scanner in scanning a document, and
(b) precluding the scanner from executing subsequently submitted scanning parameters from the scanner user interface and the printer user interface prior to the completion of the first scanning parameters.

16. The method of claim 15, further comprising locating subsequently submitted scanning parameters in a queue during execution of previously submitted scanning parameters.

17. The method of claim 15, further comprising retaining subsequently submitted scanning parameters in a queue in a first in-first out relationship.

18. The method of claim 15, further comprising repeating step (b) until the first scanning parameters are executed.

19. A system for scanning documents pursuant to user selected scanning parameters, comprising:
(a) a printer;
(b) a printer computer connected to the printer and having a printer user interface selected to receive user selected scanning parameters;
(c) a first scanner selected to scan a document in accordance with user selected scanning parameters;
(d) a first scanner computer connected to the printer computer and the first scanner to receive user selected scanning parameters for the first scanner and present the user selected scanning parameters to the first scanner;
(e) a second scanner selected to scan a document in accordance with user selected scanning parameters; and
(f) a second scanner computer connected to the printer computer and the second scanner to receive user selected scanning parameters for the second scanner and present the user selected scanning parameters to the second scanner;
the printer user interface selected to provide user selected scanning parameters for the first scanner and user selected scanning parameters for the second scanner.

20. The system of claim 19, wherein the first scanner computer includes a first scanner user interface and the second scanner computer includes a second scanner user interface, the first scanner user interface and the second scanner user interface selected to receive user selected scanning parameters for the first scanner and the second scanner.

21. A method of controlling a scanner, comprising:
(a) submitting user selected scanning parameters to the scanner from a user interface remote from the scanner; and
(b) initiating scanning pursuant to the submitted user selected scanning parameters subsequent to providing a confirmation signal at the scanner.

22. The method of claim 21, wherein submitting the scanning parameters to the scanner includes submitting the user selected scanning parameters from one of a scanner computer and a printer computer.

23. The method of claim 21, further comprising precluding the execution of a subsequently submitted scanning parameters prior to completion of the initiated scanning.

24. The method of claim 21, further comprising ordering subsequently submitted user selected scanning parameters in a queue during execution of previously submitted user selected scanning parameters.

25. The method of claim 24, further comprising subsequently submitting scanning parameters from the queue in a first in-first out sequence.

26. A method of scanning a document, comprising:
(a) submitting a set of user selected scanning parameters to a scanner from a remote location;
(b) scanning the document in accordance with the user selected scanning parameters upon providing a confirmation signal at the scanner;
(c) providing a user input signal to complete scanning in accordance with the user selected scanning parameters.

27. A control system for a document scanning system having a scanner, an independent scanner computer, a printer and an independent printer computer, the control system comprising:
(a) a lockout in one of the printer computer and the scanner computer to preclude execution of subsequently submitted user selected scanning parameters during execution of previously submitted user selected scanning parameters and

28. The control system of claim 27, further comprising a control program running one of the printer computer and the scanner computer, the control program selected to construct a set of user selected scanning parameters during precluded submission.

29. The control system of claim 27, wherein the scan setup ahead program is selected to permit modification of the user selected scanning parameters during precluded submission.
